(19) United States
(12) Patent Application Publication
(10) Pub. No.: US 2012/0113850 A1
(43) Pub. Date: May 10, 2012

(54) METHOD AND APPARATUS FOR MEASURING CHANNEL STATE INFORMATION

(75) Inventors: Jingxing FU, Beijing (CN); Chengjun Sun, Beijing (CN)

(73) Assignee: Samsung Electronics Co., Ltd., Suwon-si (KR)

(21) Appl. No.: 13/291,616

(22) Filed: Nov. 8, 2011

(30) Foreign Application Priority Data
Nov. 8, 2010 (CN) 201010539617.2
Feb. 1, 2011 (CN) 201110036092.5

(51) Int. Cl. H04W 24/00; H04L 12/26

(52) U.S. Cl. 370/252

(57) ABSTRACT

A method is provided for measuring CSI. A Macro UE determines a restricted measurement resource pattern for CSI measurement. The restricted measurement resource pattern is reported from the Macro UE to a Macro NodeB. The CSI of the restricted measurement resource pattern is measured. The CSI is reported from the Macro UE to the Macro NodeB for scheduling a data transmission resource of the Macro UE in the restricted measurement resource pattern according to the CSI.

### PRIORITY

This application claims priority under 35 U.S.C. §119(a) to applications filed in the Chinese Patent and Trademark Office on Nov. 8, 2010 and Feb. 1, 2011, and assigned Serial Nos. 201010539617.2 and 201110036092.5, respectively, the contents of which are incorporated herein by reference.

### BACKGROUND OF THE INVENTION

1. Field of the Invention

The present invention relates generally to radio communication techniques, and more particularly, to a method for measuring Channel State Information (CSI).

2. Description of the Related Art

Research has recently been conducted in using Heterogeneous Networks (HetNets) that are formed by nodes with different powers under LTE/LTE-A schemes to improve system throughput and overall network efficiency. In March 2010, a Work Item of Enhanced Inter-cell Interference Coordination for HetNet (eICIC) was established.

The eICIC is a technique capable of dramatically improving system throughput and overall network efficiency. The HetNet refers to a heterogeneous system that is formed by different nodes that cover the same area by deploying a Low Power Node (LPN) within a coverage area of a Macro NodeB. The LPN may be a Pico NodeB or a Home NodeB.

In the HetNet, one important consideration relates to the interference between nodes with the same coverage area. Specifically, the Macro NodeB may cause interference with downlink reception of LPN users since the transmission power of the Macro NodeB is much higher than that of the LPN. In addition, under a Home NodeB Closed Subscriber Group (CSG) scenario, the transmission of the Home NodeB will also cause interference with nearby Macro User Equipments (UEs).

In current 3rd Generation Partnership Project (3GPP) forums, many interference coordination methods have been proposed, such as, for example, resource segmentation and power control. One important interference coordination method is time-domain interference coordination, which is mainly used for avoiding interference caused by simultaneous data transmission in the same sub-frame by the Macro NodeB and the LPN. Specifically, time-domain interference coordination restricts one of the Macro NodeB and the LPN to transmit data in some sub-frames, so as to reduce the interference with users served by the other node.

FIG. 1 is a diagram illustrating interference in a Macro-Home case. A non-CSG Macro UE 102 incurs significant interference when gaining access to some CSG Home NodeBs. Accordingly, a Macro NodeB 104 will be unable to correctly receive control information and data. In order to solve this problem, a time-domain enhanced Inter-Cell Interference Coordination (eICIC) method has been proposed. In the time-domain eICIC method, a Home NodeB 106 generates some Almost Blank Sub-Frames (ABSFs) with very little interference through special scheduling. The control information and the data of the Macro UE 102 are scheduled only in the ABSF to ensure correct reception of the control information and the data of the Macro UE, as shown in FIG. 1.

FIG. 2 is a diagram illustrating interference in a Macro-Pico case. When a Macro NodeB 204 causes interference with users 202 of an LPN, such as, for example, a Pico NodeB 204, the above-described eICIC method may also be used at the Macro NodeB 204, as shown in FIG. 2. The Macro NodeB 204 transmits data only in sub-frames 0, 2, 5, 8 and 9, and does not transmit data in sub-frames 1, 3, 4, 6 and 7. Specifically, the sub-frames 1, 3, 4, 6 and 7 are ABSFs. Thus, the Pico NodeB 206 may schedule users 202 in the Pico cell to transmit downlink data in sub-frames 1, 3, 4, 6 and 7. As such, the interference to the users 202 in the Pico cell caused by the Macro NodeB 204 is avoided.

When a Macro NodeB and a Home NodeB coexist, when the Macro UE is not allowed access to the Home NodeB, and when the Macro UE is in the coverage area of the Home NodeB, the Home NodeB causes significant interference with the Macro UE. The time-domain eICIC method causes the Home NodeB to generate ABSFs with little interference and causes the Macro UE close to the Home NodeB to use the ABSFs generated by the Home NodeB. This method ensures that the Macro UE works and reduces the interference of the Home NodeB with the Macro UE when the Macro UE is close to the Home NodeB. However, the time-domain eICIC method requires that the Macro UE be aware of an ABSF pattern when measuring CSI to facilitate the CSI measurement and also requires that the Macro NodeB be aware of the ABSF pattern for facilitating the scheduling.

As illustrated in FIG. 3, the 3GPP standardization does not define any (X2, S1) interface for transferring the ABSF pattern between a Macro NodeB 304 and a Home NodeB 306. Therefore, the Home NodeB 306 cannot provide the ABSF pattern to the Macro NodeB 304 through X2 or S1 signaling. Further, the Macro NodeB 304 cannot provide the ABSF pattern to a Macro UE 302 through signaling, as shown in FIG. 3. Since the Macro UE 302 cannot acquire the ABSF pattern generated by the Home NodeB 306, it cannot measure the CSI in the ABSF. Subsequently, when the Macro UE 302 is within the coverage area of the Home NodeB 306, the Macro NodeB 304 cannot schedule the Macro UE 302 in the ABSF to improve the data transmission performance of the Macro UE 320 so that interference with the Home NodeB 306 is avoided.

### SUMMARY OF THE INVENTION

The present invention has been made to address at least the above problems and/or disadvantages and to provide at least the advantages described below. Accordingly, an aspect of the present invention provides a method for measuring CSI, so as to realize reasonable scheduling and effective data resource transmission.

According to one aspect of the present invention, a method is provided for measuring CSI. A Macro UE determines a restricted measurement resource pattern for CSI measurement. The restricted measurement resource pattern is reported from the Macro UE to a Macro NodeB. The CSI of the restricted measurement resource pattern is measured. The CSI is reported from the Macro UE to the Macro NodeB for scheduling a data transmission resource of the Macro UE in the restricted measurement resource pattern according to the CSI.

According to another aspect of the present invention, a Macro UE is provided for measuring CSI. The Macro UE includes a controller that determines a restricted measurement resource pattern and measures the CSI of the restricted measurement resource pattern. The macro UE also includes a memory that stores the restricted measurement resource pattern and the CSI. The macro UE further includes a transceiver that transmits the restricted measurement resource pattern and CSI to a Macro NodeB for scheduling a data transmission resource of the Macro UE in the restricted measurement resource pattern according to the CSI.

According to a further aspect of the present invention, a system is provided for measuring CSI. The system includes a Macro UE that determines a restricted measurement resource pattern for CSI measurement, reports the restricted measurement resource pattern to a Macro NodeB, measures the CSI of the restricted measurement resource pattern; and reporting the CSI to the Macro NodeB. The system also includes a Macro NodeB that receives the restricted measurement resource pattern and the CSI from the Macro UE, and schedules a data transmission resource of the Macro UE in the restricted measurement resource pattern according to the CSI.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating main interferences under a Macro-Home scenario;

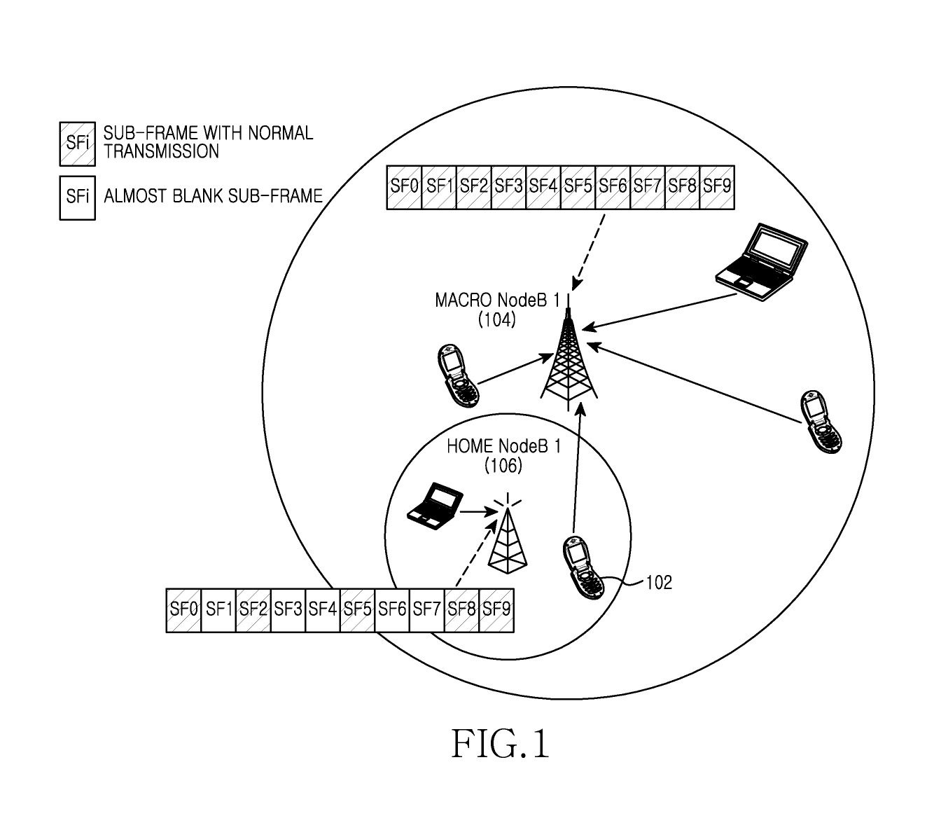

FIG. 2 is a diagram illustrating main interferences under a Macro-Pico scenario;

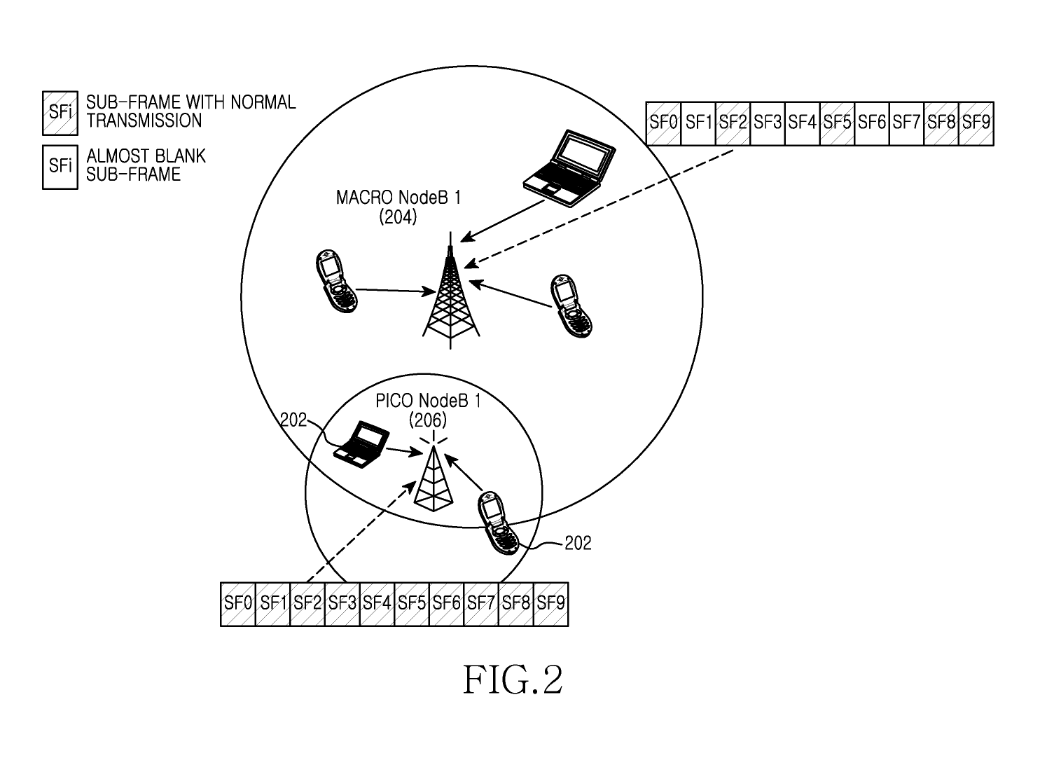

FIG. 3 is a diagram illustrating interfaces between the Macro NodeB and the Home NodeB;

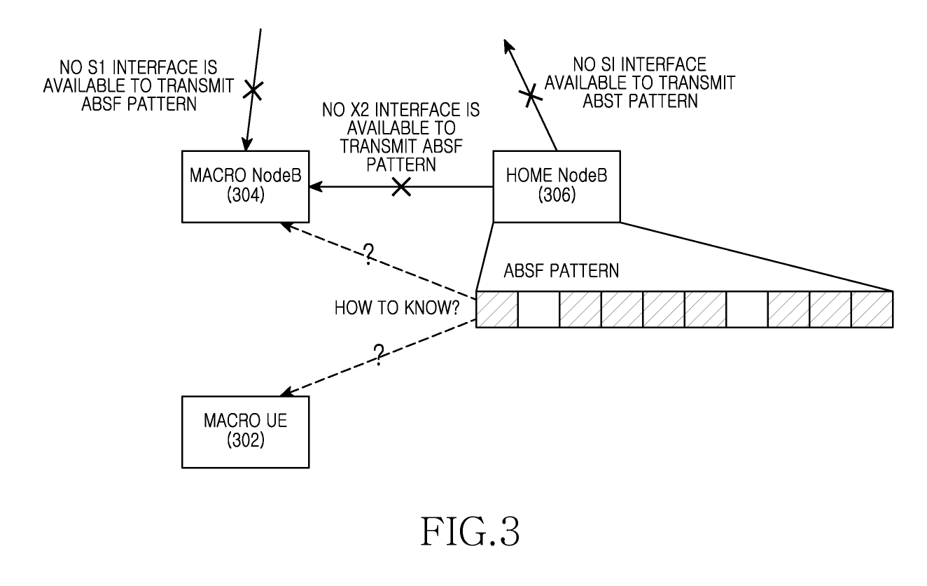

FIG. 4 is a flowchart illustrating transmission resource scheduling methodology, according to an embodiment of the present invention;

FIG. 5 is a diagram illustrating ABSF patterns of Home NodeBs, according to an embodiment of the present invention;

FIG. 6 is a diagram illustrating configuration of the ABSF pattern and a physical layer ID of the Home NodeB, according to an embodiment of the present invention;

FIG. 7 is a flowchart illustrating a method for reporting the ABSF pattern by higher-layer signaling, according to an embodiment of the present invention;

FIG. 8 is a diagram illustrating reporting of the ABSF pattern by physical layer, according to an embodiment of the present invention;

FIG. 9 is a diagram illustrating the CSI reporting time, according to an embodiment of the present invention; and

FIG. 10 is a block diagram illustrating a Macro User Equipment (UE), according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

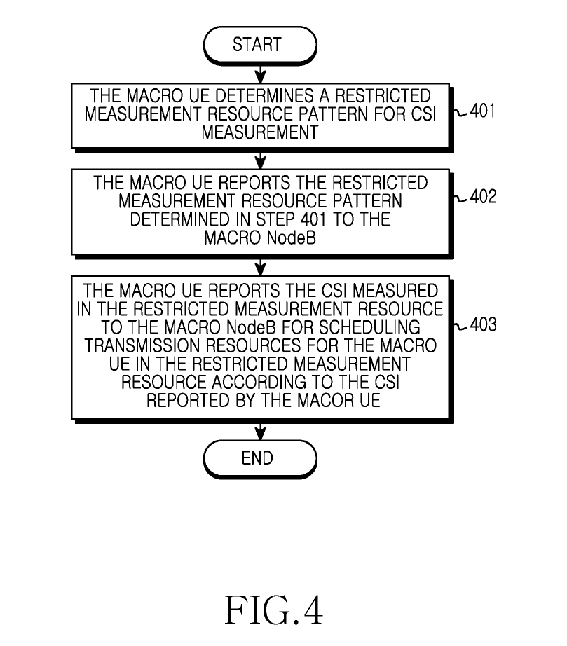

Referring initially to FIG. 4, a flow diagram illustrates a transmission resource scheduling methodology, according to an embodiment of the present invention. Specifically, FIG. 4 illustrates an embodiment in which a Macro NodeB and a Home NodeB coexist. A Macro UE determines a restricted measurement resource pattern for CSI measurement, in step 401. The restricted measurement resource pattern is reported to the Macro NodeB, in step 402. The Macro UE reports CSI measured in the restricted measurement resource pattern to the Macro NodeB for scheduling data transmission resources for the Macro UE in one or more resources of the restricted measurement resource pattern according to the CSI reported by the Macro UE, in step 403. In one implementation of step 403, the Macro UE starts to report the CSI measured in the restricted measurement resource pattern after receiving an acknowledgment transmitted by the Macro NodeB, acknowledging reception of the restricted measurement resource pattern.

When the Macro NodeB and the Home NodeB coexist, the Macro UE is able to recognize the restricted measurement resource pattern of an interfering cell and measure the CSI according to the restricted measurement resource pattern. As such, the Macro NodeB may schedule the Macro UE to transmit data in resources having little interference, so as to reduce the interference of the Home NodeB with the Macro UE.

According to an embodiment of the present invention, the methodology of FIG. 4 may start according to certain condition. Specifically, when the condition is met, the above procedure is executed. Otherwise, the measurement may be performed according to existing methods. The advantage of this embodiment is that the UE performs the recognizing of the restricted measurement resource pattern for measurement only under a certain condition, such as, for example, when the UE is close to the Home NodeB, which can avoid some unnecessary complicated measurement procedures.

For example, one condition for starting the methodology of FIG. 4 is when the UE performs a Radio Resource Management (RRM) measurement to the Home NodeB, e.g., measures a signal strength of the Home NodeB, and the measured result meets a certain condition.

In accordance with another condition for starting the methodology of FIG. 4, the UE performs the RRM measurement to the Home NodeB, e.g., measures the signal strength of the Home NodeB. If the measured result meets a certain condition, the UE reports the measured result to the Macro NodeB. Thereafter, the Macro NodeB sends a signal instructing the Macro UE to start the methodology of FIG. 4. When the Macro NodeB transmits a signal informing the Macro UE to start the methodology of FIG. 4, the Macro NodeB may inform the Macro UE of candidate patterns for recognizing the restricted measurement resource pattern, so as to enable the Macro UE to select the restricted measurement resource pattern from the candidate patterns.

Conventionally, the CSI measurement is performed in a sub-frame that meets a measurement time requirement and the measured result is reported when closest to the time. When ABSF is not introduced, the difference between CSIs of adjacent sub-frames is rather small. Therefore, the CSIs of adjacent sub-frames may be regarded as the same when scheduling transmission resources. However, when the ABSF is introduced, a difference between the CSIs of an ABSF and an adjacent non-ABSF may be very large. If the CSIs measured in the ABSF and the non-ABSF are still regarded as the same during transmission resource scheduling and the CSI measured in the ABSF is directly used, a high frame error rate may arise in the data transmission in the non-ABSF. Thus, in embodiments of the present invention, before performing the CSI measurement in step 403, the Macro UE determines the restricted measurement resource for CSI measurement, i.e. step 401, reports the determined restricted measurement resource pattern to the Macro NodeB, i.e. step 402, and then reports the CSI measured in the restricted measurement resource to the Macro NodeB. Thus, through the methodology illustrated in FIG. 4, the Home NodeB does not need to inform the Macro NodeB of the restricted measurement resource pattern through the (X2, S1) interface. Instead, the Macro UE may determine the restricted measurement resource pattern by itself. The operations performed when the Macro UE determines the restricted measurement resource pattern, are described in detail below with reference to several embodiments of the present invention.

In one embodiment of the present invention, if all Home NodeBs adopt a fixed ABSF pattern or a universal ABSF pattern that is provided from a network side, i.e., all the Home NodeBs adopt a uniform ABSF pattern, the Macro UE is able to perform CSI measurement on a Macro sub-frame pattern corresponding to the uniform ABSF pattern.

Since all the Home NodeBs adopt the uniform ABSF pattern, the Macro NodeB is able to determine the ABSF pattern. Therefore, the Macro UE does not need to report the ABSF pattern to the Macro NodeB.

Another embodiment of the present invention is applied to a situation where not all Home NodeBs adopt the uniform ABSF pattern. For example, each Home NodeB may adopt a different ABSF pattern. The Macro UE will use restricted measurement resource patterns provided by the network side or restricted measurement resource patterns defined by standards as candidate restricted measurement resource patterns. The candidate restricted measurement resource patterns are the sub-frame patterns of the Macro NodeBs corresponding to the ABSF patterns that have possibly been adopted by the Home NodeBs.

In order to reduce the complexity involved when the Macro UE determines the restricted measurement resource pattern and to increase the accuracy in recognizing the restricted measurement resource pattern, in this embodiment of the present invention, the candidate restricted measurement resource patterns provided by the network side or defined by the standards may be restricted resource patterns that correspond to certain ratios, i.e., the number of the candidate restricted measurement resource patterns is restricted to, for example, several or only one. The ratio is a proportion of the restricted resources to the total resources. For example, within a 40 millisecond (ms) periodicity, there are 40 sub-frames. A proportion of 25% of the restricted resource means that the restricted measurement resource pattern may have 10 restricted measurement resource sub-frames within the 40 sub-frames. In accordance with one specific example, the restricted measurement resource patterns corresponding to each restricted resource ratio is been defined by the standards or by the network side through signaling. For example, the restricted measurement resource patterns are defined to respectively correspond to restricted resource ratios 12.5%, 25% and 50%. When informing the Macro UE of the candidate restricted measurement resource patterns, the network side only needs to inform the Macro UE of the restricted resource ratios or the restricted resource ratios as well as the one or several candidate restricted measurement resource patterns corresponding to the ratios. Thus, the Macro UE only needs to recognize the restricted resource for measurement among the several candidate restricted measurement resource patterns. This reduces the complexity involved in recognition and increases the accuracy of recognition.

The Macro UE measures the candidate restricted measurement resource patterns so as to determine the restricted measurement resource pattern, which may be implemented in accordance with methods described in greater detail below.

In one method, a maximum CQI value is selected from among CQI values measured in the candidate restricted measurement resource patterns within a given periodicity. A candidate restricted measurement resource pattern corresponding to the selected CQI is taken as the restricted measurement resource pattern. The given periodicity includes one or several ABSF pattern periodicities.

In accordance with the embodiments of the present invention, the candidate restricted measurement resource pattern that corresponds to the maximum CQI value among the CQI values measured in the candidate restricted measurement resource patterns within the given periodicity is Pi. The CQI value measured in Pi is denoted as CQIi. The CQI value measured in a current measurement resource, e.g., the determined restricted measured resource pattern, or other current candidate restricted measurement resource patterns is denoted as CQI0. CQIi and CQI0 meet the relationship set forth below in Equation (1).

CQIi≧CQI0+Δ (1)

Δ is a real number or an integer greater than or equal to 0.

Pi is the restricted measurement resource pattern to be determined.

In order to ensure the accuracy and stability of the determination of the restricted measurement resource pattern, it is possible to add one or more filters based on the above described method to determine the restricted measurement resource pattern, which will be described in greater detail below.

If one candidate restricted measurement resource pattern has been recognized as the restricted measurement resource pattern within N consecutive ABSF pattern periodicities for a maximum number of times (the recognizing method described above), the candidate restricted measurement resource pattern is determined as the restricted measurement resource pattern to be determined. Specifically, the periodicity for determining the restricted measurement resource pattern is equal to N* ABSF pattern periodicity, where N is an integer.

For example, within M ABSF pattern periodicities among N consecutive ABSF pattern periodicities, the restricted measurement resource pattern determined according to a certain method for determining the restricted measurement resource pattern is Pi. Pi is then the restricted measurement resource pattern to be determined, and M is larger than or equal to 1 but is less than or equal to N.

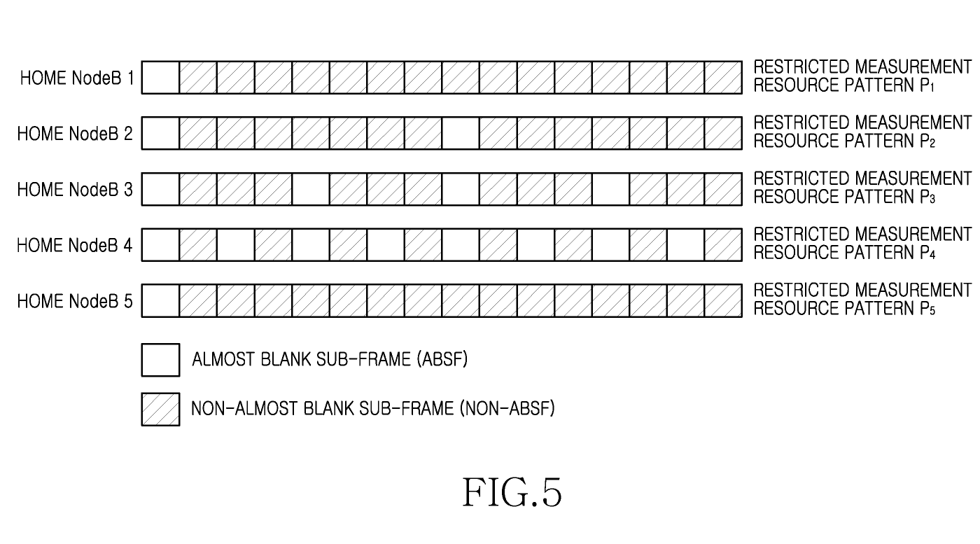

FIG. 5 is a schematic diagram illustrating a method for determining the restricted measurement resource pattern, according to an embodiment of the present invention. There are 4 candidate restricted measurement resource patterns, P1 to P4, each corresponding to Home NodeBs 1-4. Home NodeB 5 uses the candidate restricted measurement resource patter of Home NodeB 1. The candidate restricted measurement resource patterns provided by the network side may correspond to a certain frequency. Thus, the Macro UE determines the restricted measurement resource pattern among the four candidate restricted measurement resource patterns according to one or more of the methodologies described above.

If one candidate restricted measurement resource pattern has been successively recognized as the restricted measurement resource pattern for L times, the candidate restricted measurement resource pattern is determined as the restricted measurement resource pattern. For example, if the determined restricted measurement resource pattern is Pi according to a certain method for determining the restricted measurement resource pattern within L successive periodicities for determining the restricted measurement resource pattern, Pi is the restricted measurement resource pattern to be determined, and L is greater than or equal to 1 and is determined according to a recognized accuracy of the restricted measurement resource pattern.

It is also possible to determine the restricted measurement resource by any combination of the methods described above.

In an additional embodiment of the present invention, the Macro UE obtains the ABSF pattern of a nearby Home NodeB by reading system information of the Home NodeB and determines Macro NodeB sub-frame pattern corresponding to the obtained ABSF pattern as the restricted measurement resource pattern that is to be determined.

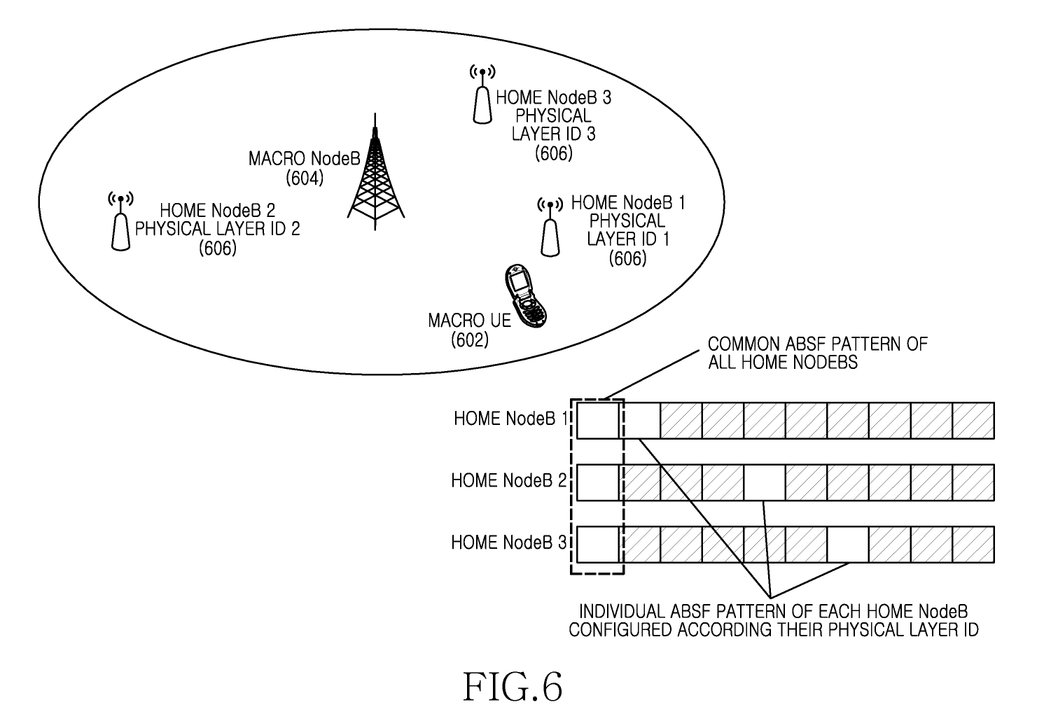

FIG. 6 is a diagram illustrating a method for configuring the ABSF pattern and a physical layer ID of the Home NodeB, according to an embodiment of the present invention. A corresponding relationship between a physical layer ID of the Home NodeB and the ABSF pattern adopted by the Home NodeB is configured. A Macro UE 602 of a Macro NodeB 604 is able to determine a physical layer ID of a nearby Home NodeB 606 and finds an ABSF pattern from the corresponding relationship according to the physical layer ID. The Macro UE 602 determines the Macro NodeB sub-frame pattern corresponding to the ABSF pattern as the restricted measurement resource pattern. The corresponding relationship between the physical layer ID and the ABSF pattern may be that the modulo of the physical layer ID is an index of the ABSF pattern of the Home NodeB 606 as set forth below in Equation (2).

PCI mod N=the index of the ABSF pattern (2)

In another embodiment of the present invention, an additional method for determining the restricted measurement resource pattern for CSI measurement by the Macro UE is set forth. The Macro UE measures Signal to Interference plus Noise Ratios (SINRs) corresponding to all possible sub-frame combinations within a first given periodicity. The first given periodicity includes one or more ABSF pattern periodicity. A maximum SINR is selected from the measured SINRs and the sub-frame combination corresponding to the selected SINR is taken as the restricted measurement resource pattern for measurement.

In yet another embodiment of the present invention, a further method for determining the restricted measurement resource pattern used for CSI measurement by the Macro UE is set forth. If the Macro UE does not suffer significant interference from nearby Home NodeB or all the downlink sub-frames of the nearby Home NodeB are ABSF sub-frames, the Macro UE takes a combination of all sub-frames within a second given periodicity as the restricted measurement resource pattern for measurement.

Additionally, in a further embodiment of the present invention, the Macro UE measures all possible combinations of the sub-frames within a fixed periodicity and determines the restricted measurement resource pattern according to anyone of the methods described above.

The operations performed when the Macro UE reports the restricted measurement resource pattern to the Macro NodeB are described in detail below.

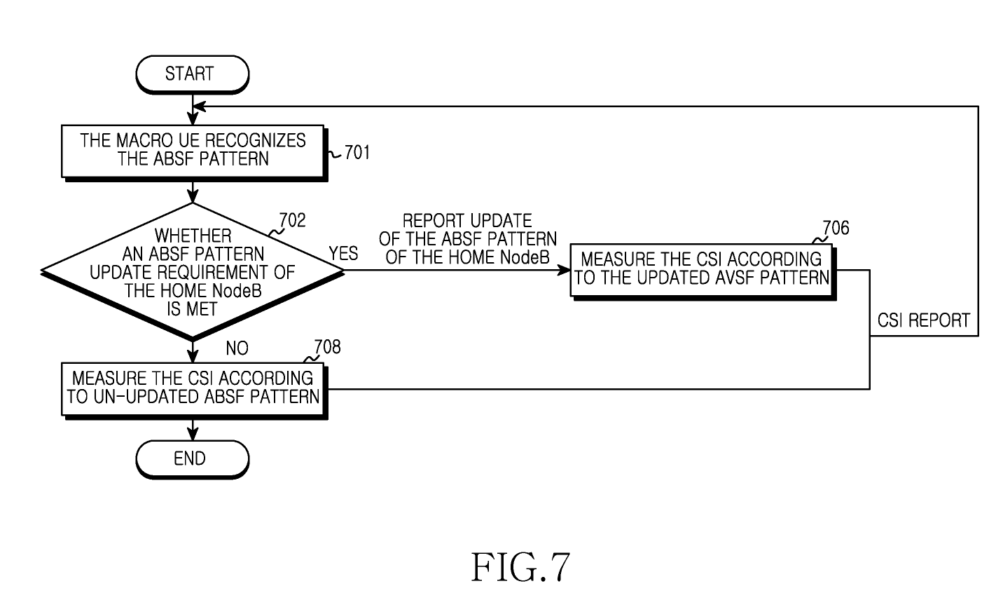

FIG. 7 is a diagram illustrating a method for reporting the ABSF pattern by higher-layer signaling, according to an embodiment of the present invention. The reporting of the restricted measurement resource pattern is aperiodic and event-driven. The Macro UE recognizes that the ABSF pattern of the Home NodeB, in step 702. It is determined whether an ABSF pattern update requirement is met in step, 704. If the requirement is met, the CSI is measured according to the updated ABSF pattern, in step 706 and the changed restricted measurement resource pattern is reported to the Macro NodeB. If the requirement is not met, the CSI is measured according to an un-updated ABSF pattern, in step 708. The changed restricted measurement resource pattern is the Macro NodeB sub-frame pattern corresponding to the changed ABSF pattern.

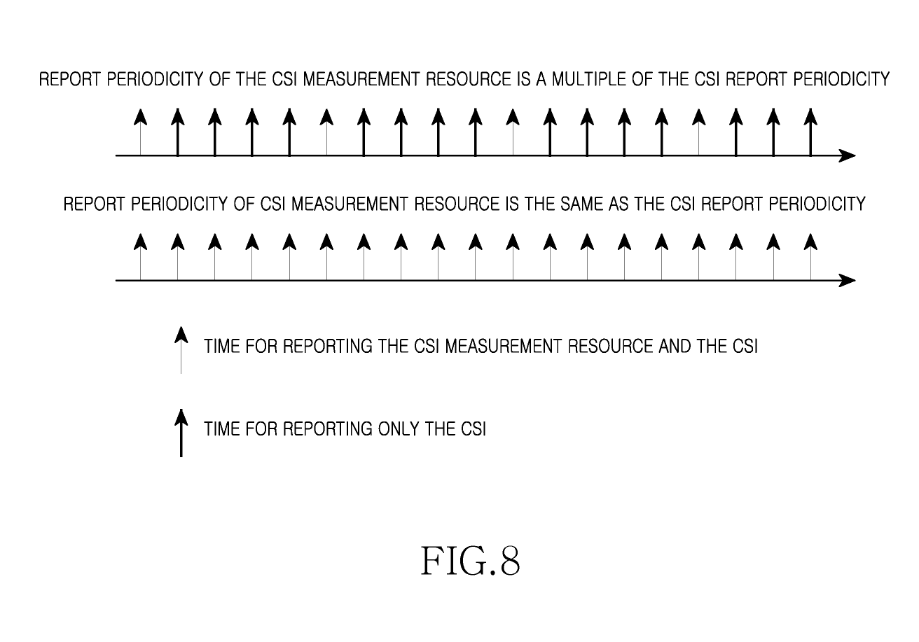

Referring to FIG. 8, a diagram illustrates reporting the ABSF pattern by a physical layer, according to an embodiment of the present invention. It is possible to periodically report the restricted measurement resource pattern through physical layer control information. The transmission of the restricted measurement resource pattern is periodic. Specifically, whether the restricted measurement resource pattern changes or not, the Macro UE transmits the restricted measurement resource pattern to the Macro NodeB. The periodicity for transmitting the restricted measurement resource pattern may be the same as the CSI periodicity or may be equal to a value several times the CSI periodicity, as shown in FIG. 8.

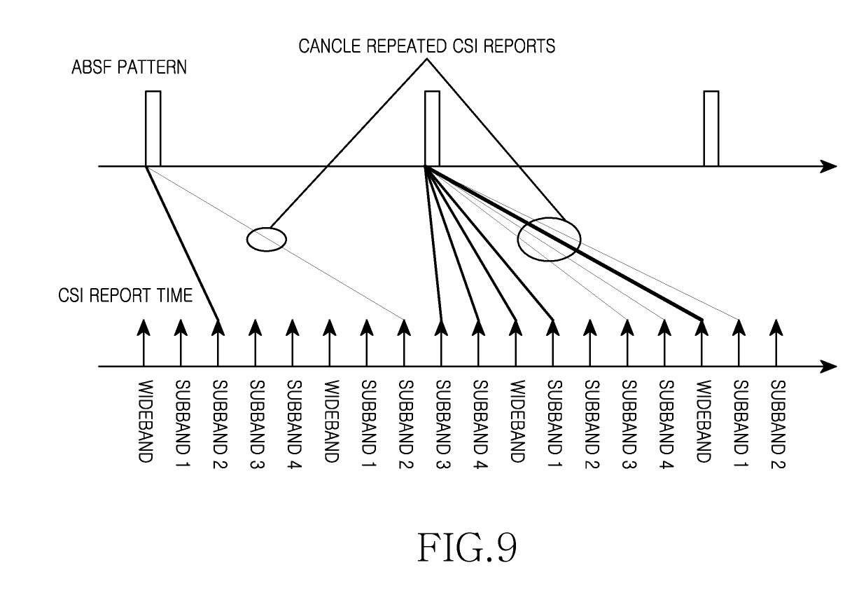

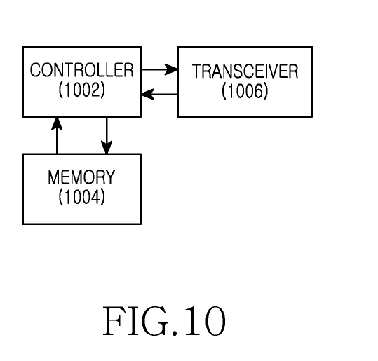

FIG. 9 is a diagram illustrating the CSI reporting time, according to an embodiment of the present invention. Since the periodicity of the restricted measurement resource pattern and the CSI reporting period do not match, when the same CSI measured according to the same ABSF resource needs to be reported at different times, the repeated unnecessary CSI reports may be cancelled, as shown in FIG. 9. Referring to FIG. 10, a diagram illustrates a Macro UE, according to an embodiment of the present invention. The Macro UE includes a controller 1002 that determines a restricted measurement resource pattern and measures the CSI of the restricted measurement resource pattern. The Macro UE also includes a memory that stores the restricted measurement resource pattern and the CSI. The Macro UE further includes a transceiver (1004) that transmits the restricted measurement resource pattern and CSI to the Macro NodeB.

In embodiments of the present invention, the Macro UE obtains the restricted measurement resource pattern, measures the CSI in the restricted measurement resource pattern and reports the CSI to the Macro NodeB. In addition, the recognized restricted measurement resource pattern is also reported to the Macro NodeB. Thus, the Macro NodeB is able to perform scheduling on the resources indicated by the CSI. The method provided by embodiments of the present invention may measure the CSI in the resources with little interference and let the Macro NodeB schedule the Macro UE to transmit data in these resources, so as to reduce the interference of the Home NodeB with the Macro UE.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for measuring Channel State Information (CSI), comprising the steps of:
determining, by a Macro User Equipment (UE), a restricted measurement resource pattern for CSI measurement;
reporting the restricted measurement resource pattern from the Macro UE to a Macro NodeB;
measuring the CSI of the restricted measurement resource pattern; and
reporting the CSI from the Macro UE to the Macro NodeB for scheduling a data transmission resource of the Macro UE in the restricted measurement resource pattern according to the CSI.

2. The method of claim 1, wherein the restricted measurement resource pattern is a Macro NodeB sub-frame pattern corresponding to an Almost Blank Sub-Frame (ABSF) pattern configured by a Low Power Node (LPN), and the restricted measurement resource pattern is determined by the Macro UE via reading system information of the LPN.

3. The method of claim 1, wherein determining the restricted measurement resource pattern comprises:
selecting a maximum CQI value from CQI values measured in candidate restricted measurement resource patterns within a configured periodicity; and
setting a candidate restricted measurement resource pattern corresponding to the maximum CQI value as the restricted measurement resource pattern;
wherein the configured periodicity comprises one or more ABSF pattern periodicities.

4. The method of claim 1, wherein determining the restricted measurement resource pattern comprises:
setting a candidate restricted measurement resource pattern as the restricted measurement resource pattern, when the candidate restricted measurement resource pattern is recognized as the restricted measurement resource pattern a maximum number of times within N consecutive ABSF pattern periodicities.

5. The method of claim 1, wherein determining the restricted measurement resource pattern comprises:
setting a candidate restricted measurement resource pattern as the restricted measurement resource pattern, when the candidate restricted measurement resource pattern is successively recognized as the restricted measurement resource pattern L times, wherein L is determined by a recognition accuracy of the restricted measurement resource pattern.

6. The method of claim 1, wherein determining the restricted measurement resource pattern comprises:
measuring, by the Macro UE, Signal to Interference Plus Noise Ratios (SINRs) corresponding to all possible combinations of sub-frames within a first given periodicity;
selecting a maximum SINR from the measured SINRs; and
setting a sub-frame combination corresponding to the maximum SINR as the restricted measurement resource pattern.

7. The method of claim 1, wherein determining the restricted measurement resource pattern comprises:
setting, by the Macro UE, a combination of all sub-frames within a second given periodicity as the restricted measurement resource pattern, when the Macro UE does not have significant interference from a nearby LPN, or when all downlink sub-frames of the nearby LPN are ABSF sub-frames.

8. The method of claim 1, wherein determining the restricted measurement resource pattern comprises:
determining, by the Macro UE, a physical layer ID of a nearby LPN;
finding an ABSF pattern corresponding to the physical layer ID according to a corresponding relationship between the physical layer ID of the LPN and the ABSF pattern; and
setting a Macro NodeB sub-frame pattern corresponding to the determined ABSF pattern as the restricted measurement resource pattern.

9. The method of claim 1, wherein reporting the restricted measurement resource pattern comprises:
when it is recognized that an ABSF pattern of a nearby LPN changes, transmitting, by the Macro UE, a changed restricted measurement resource pattern to the Macro NodeB through higher layer signaling, wherein the changed restricted measurement resource pattern is a Macro NodeB sub-frame pattern corresponding to the changed ABSF pattern.

10. The method of claim 1, wherein reporting the restricted measurement resource pattern comprises:
transmitting, by the Macro UE, the restricted measurement resource pattern to the Macro NodeB periodically through physical layer channel control information.

11. The method of claim 1, further comprising cancelling, by the Macro UE, repeated CSI reports measured according to a same restricted measurement resource pattern.

12. The method of claim 1, wherein the Macro UE reports the CSI when an acknowledgment is received from the Macro NodeB acknowledging the restricted measurement resource pattern.

13. The method of claim 1, wherein the restricted measurement resource pattern is determined and reported, and the CSI is reported, when a measured result of a Radio Resource Management (RRM) measurement performed by the Macro UE to an LPN meets a pre-defined condition.

14. The method of claim 13, wherein the restricted measurement resource pattern is determined and reported, and the CSI is reported, when the Macro UE receives an indication to start from the Macro NodeB through signaling.

15. The method of claim 14, wherein candidate restricted measurement resource patterns are provided in the indication.

16. The method of claim 1, wherein candidate restricted measurement resource patterns are defined by standards.

17. The method of claim 1, wherein candidate restricted measurement resource patterns are determined according to ratios defined by a network side through signaling.

18. A Macro User Equipment (UE) for measuring Channel State Information (CSI) comprising:
a controller that determines a restricted measurement resource pattern and measures the CSI of the restricted measurement resource pattern;
a memory that stores the restricted measurement resource pattern and the CSI; and
a transceiver that transmits the restricted measurement resource pattern and CSI to a Macro NodeB for scheduling a data transmission resource of the Macro UE in the restricted measurement resource pattern according to the CSI.

19. A system for measuring Channel State Information (CSI) comprising:
a Macro User Equipment (UE) that determines a restricted measurement resource pattern for CSI measurement, reports the restricted measurement resource pattern to a Macro NodeB, measures the CSI of the restricted measurement resource pattern; and reporting the CSI to the Macro NodeB; and
a Macro NodeB that receives the restricted measurement resource pattern and the CSI from the Macro UE, and schedules a data transmission resource of the Macro UE in the restricted measurement resource pattern according to the CSI.
